(19) United States
(12) Patent Application Publication
(10) Pub. No.: US 2024/0405194 A1
(43) Pub. Date: Dec. 5, 2024

(54) ELECTRODES, JOINTS AND METHODS OF FABRICATION THEREOF

(71) Applicant: National University of Singapore, Singapore (SG)

(72) Inventors: Sergio Graniero Echeverrigaray, Singapore (SG); Vivek Nair, Singapore (SG); Antonio Helio De Castro Neto, Singapore (SG)

(21) Appl. No.: 18/699,541

(22) PCT Filed: Oct. 7, 2022
(86) PCT No.: PCT/SG2022/050719

§ 371 Date: Apr. 8, 2024

(30) Foreign Application Priority Data
Oct. 8, 2021 (SG) 10202111213Y

(51) Int. Cl. H01M 4/133; H01M 4/02; H01M 4/04; H01M 4/1393; H01M 4/62; H01M 4/66; H01M 50/533; H01M 50/536

(52) U.S. Cl. CPC H01M 4/133; H01M 4/0404; H01M 4/0416; H01M 4/043; H01M 4/1393; H01M 4/623; H01M 4/625; H01M 4/663; H01M 50/533; H01M 50/536; H01M 2004/021; H01M 2004/028

(57) ABSTRACT

The present disclosure concerns an electrode comprising a plurality of porous conductive substrates and at least one layer of an electrode composite material, the at least one layer of electrode composite material is sandwiched between the plurality of porous conductive substrates, the at least one layer of electrode composite material in electrical communication with the plurality of porous conductive substrates. The electrode composite material at least partially impregnates the plurality of porous conductive substrates. The present disclosure also concerns joints and methods of fabricating the electrodes and joints.

### TECHNICAL FIELD

The present invention relates, in general terms, to electrodes, joints and their methods of fabrication thereof.

### BACKGROUND

The cell architecture is the core part of batteries, e.g., lithium-ion (Li-ion) and lithium-sulphur (Li—S) batteries. The electrode composite materials (ECM) typically comprise active materials, additives, and binders coated onto electronic conductive substrates (current collectors, e.g. metal foils) to form the electrodes. Several approaches have been used to increase the energy density and/or reduce the cost of Li-ion batteries, such as developing new active materials, optimising cell engineering, optimising materials processing, and improving quality control. The gradual improvement of ˜3 times in energy density over the last two decades mainly was due to cell engineering, which has increased the volume ratio of active materials from ˜20% in early Li-ion cells (200 Wh L⁻¹) to ˜45% in today's state-of-art cells (550 to 600 Wh L⁻¹).

Thickening the electrodes in a battery cell by increasing the active material loading while making current collectors and separators thinner is one approach to obtain higher energy density and low-cost batteries. The physics-based factors that limit the energy and power densities of thick electrodes were found to be the increased cell polarisation and the underutilisation of active materials. The latter is affected by Li-ion diffusion in the active materials and Li-ion depletion in the electrolyte phase.

It would be desirable to overcome or ameliorate at least one of the above-described problems.

### SUMMARY

The inventors have found that the active material loading on the electrodes can be increased by stacking together two or more electrode layers with at least one connecting component between the electrode layers and laminating them. The connecting component can be a conductive porous substrate with similar or dissimilar mass loadings to form a single electrode, resulting in high active material loading per area on the electrode, thereby increasing the areal capacity and improving the battery's energy density.

The present invention provides an electrode, comprising:
a) a plurality of porous conductive substrates; and
b) at least one layer of an electrode composite material, the at least one layer of electrode composite material is sandwiched between the plurality of porous conductive substrates, the at least one layer of electrode composite material in electrical communication with the plurality of porous conductive substrates;
wherein the electrode composite material at least partially impregnates the plurality of porous conductive substrates.

This arrangement encases the electrode composite material between and within the porous conductive substrate such that the electrode composite material does not form an external/outer face of the electrode.

In some embodiments, the plurality of porous conductive substrate and the at least one layer of electrode composite material are laminated to each other.

In some embodiments, the at least one layer of electrode composite material is at least two layers of electrode composite material.

In some embodiments, the porous conductive substrate and the layers of electrode composite material have substantially the same planar area.

In some embodiments, the porous conductive substrate is characterised by a larger planar area than a planar area of the layers of electrode composite material by about 1% to about 50%.

In some embodiments, the electrode further comprises a binder in contact with its lateral sides to electronically connect the lateral sides of the electrode composite material to the porous conductive substrate.

In some embodiments, the binder is an aqueous binder, a non-aqueous binder, or a combination thereof.

In some embodiments, the porous conductive substrate is surface functionalised.

In some embodiments, the porous conductive substrate is functionalised with transition metal sulphides, transition metal selenides, halides, metal ions, nanoparticles, metal oxides, or a combination thereof.

In some embodiments, each layer of porous conductive substrate is independently characterised by a thickness of about 10 μm to about 1000 μm.

In some embodiments, the porous conductive substrate is selected from carbon paper, carbon cloth, carbon foam, carbon fibre, porous metallic structures, grids and foams, porous conductive polymers, conductive polymeric gels and aerogels, thin films, or a combination thereof.

In some embodiments, each layer of electrode composite material is independently characterised by a thickness of about 0.1 μm to about 1000 μm.

In some embodiments, the electrode composite material comprises a carbon-based material, a metal-based material, a metal oxide based material, an electrochemically active material, a polymeric material or a combination thereof.

In some embodiments, the electrode composite material is characterised by an absence of electrically conductive material, binder, filler, or a combination thereof.

In some embodiments, the electrode composite material comprises an electrically conductive nanoparticle.

In some embodiments, the electrically conductive nanoparticle comprises graphene, carbon black, acetylene black, carbon nanotubes, metallic nanoparticles, carbon dots, or a combination thereof.

In some embodiments, the electrically conductive nanoparticles are surface functionalised with different oxidation states of halides, chalcogenides, metals, or a combination thereof.

In some embodiments, a weight ratio of electrically conductive nanoparticles relative to the electrode composite material is about 3 wt % to about 50 wt %.

In some embodiments, a weight ratio of electrically conductive nanoparticles relative to the electrode composite material is about 10 wt %.

In some embodiments, the electrode composite material further comprises a conductive filler.

In some embodiments, the conductive filler is a conductive carbon-based material, a metal or combination thereof.

In some embodiments, a weight ratio of the conductive filler relative to the electrode composite material is about 1 wt % to about 30 wt %.

In some embodiments, a weight ratio of the conductive filler relative to the electrode composite material is about 10 wt %.

In some embodiments, the electrode composite material further comprises a binder.

In some embodiments, the binder is polyvinylidene fluoride, gum Arabic, cellulose gum, polyvinyl alcohol, carboxymethyl cellulose, styrene-butadiene rubber, or a combination thereof.

In some embodiments, a weight ratio of the binder relative to the electrode composite material is about 1 wt % to about 20 wt %.

In some embodiments, a weight ratio of the binder relative to the electrode composite material is about 10 wt %.

In some embodiments, the electrode is characterised by an absence of a separator between the electrode composite material.

In some embodiments, the electrode is characterised by a discharge capacity of about 50 mAh g_{active material}⁻¹ to about 4000 mAh g_{active material}⁻¹.

In some embodiments, the electrode is characterised by an areal capacity of about 2 mAh cm⁻² to about 100 mAh cm⁻² per layer of stack.

In some embodiments, the electrode is characterised by an electronic conductivity of about 1.5 S cm⁻¹ to about 100 S cm⁻¹.

In some embodiments, the electrode is characterised by a capacity loss of about 5% to about 50% relative to its initial capacity.

In some embodiments, the electrode is characterised by a Coulombic efficiency of about 70% to about 100%.

In some embodiments, the electrode is characterised by a cycle life of more than 40 cycles.

In some embodiments, the electrode further comprises a joint adapted to pass through the electrode.

In some embodiments, the joint is adapted to pass through a through hole formable in the electrode.

In some embodiments, the joint comprises a body adapted to substantially pass through the electrode.

In some embodiments, the body is characterised by a cross-sectional shape selected from a circle, oval, or polygon.

In some embodiments, the body is hollowed.

In some embodiments, when the body is characterised by a polygonal cross-sectional shape and is hollowed, the body comprises legs extending from edges of the polygon.

In some embodiments, the joint further comprises a head at a first end of the body.

In some embodiments, the body is deformable to form a head.

In some embodiments, the joint comprises an electrically conductive material.

In some embodiments, the electrically conductive material is selected from metals, alloys or composites.

In some embodiments, the electrically conductive material is selected from stainless steel, Al, Ti, Ni, or Cu.

In some embodiments, when the electrode is a cathode, the electrically conductive material is selected from stainless steel, Al, Ti, or Ni.

In some embodiments, when the electrode is an anode, the electrically conductive material is selected from stainless steel, Ni or Cu.

In some embodiments, the joint is adapted to electrically connect two or more electrodes.

In some embodiments, the joint is adapted to electrically connect at least one electrode to at least one contact tab.

In some embodiments, the joint is adapted to electrically connect at least one electrode to at least one lead.

In some embodiments, the joint is adapted to electrically connect at least one contact tab to at least one lead on the electrode.

The present invention provides a method of fabricating an electrode, comprising:
a) forming at least one electrode layer, the at least one electrode layer is formed by coating a layer of electrode composite material on at least a surface of a porous conductive substrate; and
b) stacking the at least one electrode layer with another porous conductive substrate such that the layer of the electrode composite material is sandwiched between the porous conductive substrates, the at least one electrode layer in electrical communication with the porous conductive substrates;
wherein the electrode composite material at least partially impregnates the porous conductive substrates.

In some embodiments, the method further comprises a step of stacking another electrode layer on the porous conductive substrate of step a) or b).

In some embodiments, the electrode composite material is provided as a slurry, dough, paste, or powder.

In some embodiments, the electrode composite material is characterised by a mass loading on the surface of the porous conductive substrate of about 1 mg cm⁻² to about 100 mg cm⁻².

In some embodiments, the stacking step comprises subjecting the electrode layer and the another porous conductive substrate to a compressive force.

In some embodiments, the compressive force is provided by a hydraulic press, a pneumatic press, gravimetric press or a roller press.

In some embodiments, the method further comprises connecting a joint to the electrode.

In some embodiments, the joint is connected to the electrode via punching or via a through-hole formed in the electrode.

In some embodiments, the joint comprises a body, wherein the body is deformable to form a head.

In some embodiments, the body is deformed by bending an end of the body such that the head is substantially parallel to a surface of the electrode.

In some embodiments, the body is bent in a direction away from its longitudinal axis.

The present invention also provides a method of connecting a joint to an electrode, comprising:
a) passing a body of the joint through the electrode; and
b) deforming the body of the joint in order to form a head for connecting the joint to the electrode.

### BRIEF DESCRIPTION OF THE DRAWINGS

Embodiments of the present invention will now be described, by way of non-limiting example, with reference to the drawings in which:

FIG. 1 shows examples of stacked configurations using (A) single porous conductive substrate (or current collector; CC) surface completely coated with electrode composite material (ECM), (B) dual CC surface completely coated with ECM, (C) four electrodes comprised of two single CC surface and two dual surfaces surface completely coated with ECM before compression, (D) final four electrodes stacked with EMC partially exposed, (E) single CC surface partially coated with ECM, (F) dual CC surface partially coated with ECM, (G) four electrodes comprised of two single CC surface and two dual surfaces surface partially coated with ECM before compression, and (H) final four electrodes stacked with ECM enclosed among CCs.

FIG. 2 shows examples of methods for (A) continuous stacking of two single CC surface coated with ECM and one dual CC surfaces coated with ECM by roller pressing and (B-C) batch stacking of two single CC surface coated with ECM and two dual CC surfaces coated with ECM by pneumatic/hydraulic pressing to form stacked electrode (SE).

FIG. 3 shows first specific discharge capacity for a cell made with two individual electrodes staked together at 0.05 C-rate.

FIG. 4 shows specific discharge capacity for a cell made with two individual electrodes staked together at 0.25 C-rate.

FIG. 5 shows examples of shapes and formats of the joints. (A) Example of cylindrical joint with and without a pre-conformed head, a cylindrical head with cubic legs, and joint with the shape of a two-pronged fastener connected by a head. (B) Examples of optimised joint legs' shape and legs with flanges/holes to have reduced weight in a joint with cubic hole. (C) Example of different hole shapes and joint' leg shapes (independent of the head shape).

FIG. 6 shows schematic example of a joint with the shape of a two-pronged fastener connected by a head joining an electrode and a tab/lead; and example of joining method: (A) joint is forced into the electrode and tab/lead perforating them, (B) joint legs are bend inwards or outwards to join the electrode and tab/lead, and (C) final electrode with tab/lead joined.

FIG. 7 shows examples of methods to join electrodes, tabs, and/or leads. (A) Electrodes, tabs, and/or leads, (B) preformation of the holes (optional, can be done for example by puncturing or drilling), (C) preformed holes viewed from the top, (D) insertion of joint with or with-out preformed head, (E) joint legs (and head in the case of joints without preformed head) are flared/collared/bent outwards to join the electrodes, tabs, and/or leads, and (F) final electrodes, tabs, and/or leads joined.

FIG. 8 shows a schematic example of a joint comprised of three parts (two heads and a leg) and method to assemble them.

FIG. 9 shows images to exemplify the use of aluminium joints connecting an aluminium tab to a cathode electrode that uses carbon paper as a current collector. The front view of the electrode is presented on the left, and on the right, the back-view of the electrode.

FIG. 10 shows specific discharge capacity after formation cycling for a cell made with dry electrode composite material (in powder form, 3 mg cm⁻²) staked between two porous current collectors at 0.6 C-rate. No binder or extra conductive carbon were used in the electrode composition.

FIG. 11 shows specific charge/discharge capacity profile for a cell made with dry electrode composite material (in powder form, 3 mg cm⁻²) staked between two porous current collectors at 0.1 C-rate. No binder or extra conductive carbon were used in the electrode composition.

### DETAILED DESCRIPTION

Typically, Li-ion and Li—S batteries have an active material loading of 25 to 30 mg cm-2 and 1 to 5 mg cm⁻², respectively. Increasing the active material loading on the electrodes in alkali-sulphur batteries comes with the cost of reduced electrical conductivity throughout the electrode bulk, poor wetting of the electrodes, underutilisation of active materials, and increased cell polarisation.

To allow electrons to enter and leave a battery electrode, it is helpful to have electrode active material in electronic communication with a current collector, which, in turn, is in electronic communication with an outside load. During battery cycling, stresses can occur in the electrode, and contact between the active material and its current collector can be broken, causing reduced performance or failure of the battery.

The inventors have found that the active material loading on the electrodes can be increased by stacking them together as two or more electrode layers with interposed connecting components. These layers may then be laminated. The connecting component serves to separate the two or more electrode layers, and may be a conductive porous substrate with similar or dissimilar mass loadings to form a single electrode, resulting in high active material loading per area on the electrode, thereby increasing the areal capacity and improving the battery's energy density.

For example, electrode material can be directly stacked with porous and electronic conductive substrates to improves areal capacity. This improves volumetric and gravimetric energy densities to facilitate scalable and sustainable manufacturing. Direct contact of conductive substrates that act as current collector reduces the cell polarisation and improve electronic conductivity. This provides a higher rate of power capabilities. Restricting the electrode composite materials between porous substrates helps on holding electrolyte-soluble electro-active species preventing irreversible capacity loss. This improves cycle life and columbic efficiency. Additionally, multiple stacked electrode configuration provides room for volume expansion into the conductive substrate's pores and prevents loss of material due to structural collapse caused by volumetric changes. In this way, higher active material utilisation, capacities and capacity retention can be achieved. It also allows the use of high capacity materials like silicon and sulphur with higher volume expansion issues.

Accordingly, the present invention provides an electrode, comprising:
a) a plurality of porous conductive substrates; and
b) at least one layer of an electrode composite material, the at least one layer of electrode composite material is sandwiched between the plurality of porous conductive substrates, the layer of electrode composite material in electrical communication with the plurality of porous conductive substrates;
wherein the electrode composite material at least partially impregnates the plurality of porous conductive substrates.

In some embodiments, the present invention provides an electrode, comprising:
a) a plurality of porous conductive substrates; and
b) at least two layers of an electrode composite material, each layer of electrode composite material is sandwiched between the porous conductive substrates, the at least two layers of electrode composite material in electrical communication with the porous conductive substrates;
wherein the electrode composite material at least partially impregnates the plurality of porous conductive substrates.

At least a single layer or multiple layers of electrode composite materials may be stacked and compressed to form a single indivisible electrode with all the layers physically separated but electronically connected without the use of additional tabs. The external faces of the electrode are coated by the porous conductive substrate and hence electrically protects the electrode composite material within. The porous conductive substrate functions not only as the current collector but also as an active filter or trap electroactive materials and electrolyte soluble active-material due to its porosity. This functionality helps address the issues attached with electrolyte soluble active material losing electrical contact and contain the structural collapse of the coating due to eventual volume changes, and which cannot be performed by a separator. Additionally, the porosity present within the porous conductive substrate helps in homogeneously wetting of the electrode composite material. This also allows the electrolyte to homogenously penetrate the electrode such that the electrode composite material deep within the electrode can be contacted with electrolyte.

In some embodiments, the plurality of porous conductive substrate and the layer of electrode composite material are laminated to each other. In some embodiments, the plurality of porous conductive substrate and the at least two layers of an electrode composite material are laminated to each other. As used herein, “laminate” refers to two or more layers of material which are rolled or compressed together such that the interface of the layers are fused together. A laminate is a permanently assembled object created using heat, pressure, welding, or adhesives. Various coating machines, machine presses and calendering equipment may be used. In the present context, the layers of material may be a layer of porous conductive substrate interfaced with a layer of electrode composite material.

In some embodiments, the electrode composite material at least partially impregnates the porous conductive substrate. In this way, the layers of electrode composite material are physically separated from each other. In other embodiments, the electrode composite material fully impregnates the porous conductive substrate. This is done without compromising the extruture of the porous conductive substrate; i.e. the passing of the electrode composite material from one surface of the porous conductive substrate through the opposite surface of the porous conductive substrate. The impregnation provides enhanced electrical conductivity for the electrodes and being sandwiched prevents any material dissolution in electrolytes. This type of electrodes are particularly useful for building cathodes for Li—S batteries where polysulfide dissolution is a challenge and for LiMn₂O₄ cathode where manganese dissolution is a challenge. It also provides room for volume expansion and prevents withering of active materials and is very useful for silicon based anodes.

In some embodiments, the electrode composite material impregnates the porous conductive substrate by at least about 10%. In this regard, 10% of the thickness (or volume) of the porous conductive substrate comprises electrode composite material. In other embodiments, the electrode composite material impregnates the porous conductive substrate by at least about 20%, about 30%, about 40%, about 50%, about 60%, about 70%, about 80%, or about 90%, or about 100%.

The electrode composite material is positioned such that each planar side thereof is connected to a porous conductive substrate. In this regard, the electrode has external facing sides which comprises the porous conductive substrate. Having the porous conductive substrate on the external surfaces protects the inner electrode composite material from oxidation.

The electrode can be formed from porous conductive substrate and electrode composite material of substantially the same dimensions. In some embodiments, the porous conductive substrate and the layers of electrode composite material has substantially the same planar area. When formed in this manner, the edges (or lateral sides) of the electrode composite material is exposed; i.e. not covered by the porous conductive substrate.

Alternatively, the electrode composite material can be of a smaller dimension compared to that of the porous conductive substrate. When the electrode composite material is applied as a layer which is centered about the porous conductive substrate, this results in a border surrounding the electrode composite material. The border can have a thickness of about 1 mm to about 10 cm, or about 1 mm to about 9 cm, about 1 mm to about 8 cm, about 1 mm to about 7 cm, about 1 mm to about 6 cm, about 1 mm to about 5 cm, about 1 mm to about 4 cm, about 1 mm to about 3 cm, about 1 mm to about 2 cm, or about 1 mm to about 1 cm.

In some embodiments, the porous conductive substrate is characterised by a planar area which is larger than a planar area of the layers of electrode composite material by about 1% to about 50%. In other embodiments, the size difference is about 1% to about 45%, about 1% to about 40%, about 1% to about 35%, about 1% to about 30%, about 1% to about 25%, about 1% to about 20%, about 1% to about 15%, or about 1% to about 10%.

Accordingly, the formed electrode comprises layers of electrode composite material which are completely encased by the porous conductive substrate. This minimises rate of oxidation of the electrode composite material, and thus extends the lifespan of the electrode.

The border can be filled with a binder. In some embodiments, the electrode further comprises a binder in contact with its lateral sides thereof. This allows for electrical connection of the lateral sides of the electrode composite material to the porous conductive substrate.

Electronically conductive binders include conductive polymer binders such as graphene polymer binders and polyfluorene polymer binders and binders having conductive particle additives.

The binder may be a non-aqueous binder, an aqueous binder, or a combination thereof. The binder is not particularly limited as long as it binds the active material and the conductive material on a current collector, and simultaneously (or concurrently) has no electrochemical degradation.

Non-aqueous binders can be, but not limited to, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, polyamideimide, polyimide, or a combination thereof.

Aqueous binders can be either natural, modified, or synthesised materials include, but are not limited to, a rubber-based, a polymer resin, or a polysaccharide binder. Rubber-based binders may be selected from styrene-butadiene rubber, acrylated styrene-butadiene rubber (SBR), acrylonitrile-butadiene rubber, acrylic rubber, butyl rubber, fluorine rubber, natural rubber, and a combination thereof. Polymer resin binders may be selected from ethylenepropylene copolymer, epichlorohydrin, polyphosphazene, polyacrylonitrile, polystyrene, ethylenepropylenediene copolymer, polyvinylpyridine, chlorosulfonated polyethylene, a polyester resin, an acrylic resin, a phenolic resin, an epoxy resin, polyvinyl alcohol and a combination thereof.

Polysaccharide binders may be selected from carboxylmethyl cellulose, hydroxypropylmethyl cellulose, methyl cellulose, or their alkali metal salts thereof, gum tragacanth, gum arabic, gellan gum, xanthan gum, guar gum, karaya gum, chitosan, sodium alginate, cyclodextrin, starches, and a combination thereof. The alkali metal may be Na, K, or Li. Such a cellulose-based compound may be included in an amount of about 0.1 parts by weight to about 20 parts by weight based on 100 parts by weight of the active material. Preferable binders that may be mentioned herein are the sodium salt of carboxylmethyl cellulose, gum Arabic, polyvinyl alcohol, or a combination thereof.

In some embodiments, the binder is gum Arabic, polyvinyl alcohol, carboxylmethyl cellulose, styrene-butadiene rubber, polyvinylidene fluoride or a combination thereof.

An electrode composite material is a material which is produced from two or more constituent materials, one of which is a chemically active material that participates in the electrochemical charge/discharge reaction. For reference, the theoretical capacity of silicon is 4200 mAh/g. Examples of high capacity materials for lithium ion electrodes can include various silicon-containing materials, such as crystalline silicon, amorphous silicon, silicides, silicon oxides, sub-oxides, and oxy-nitrides. Other examples include sulfur and its composites with carbon, metal or metal oxides, tin-containing materials (such as tin and tin oxide), transitional metal sulfides and selenides, germanium-containing materials, carbon-containing materials, a variety of metal hydrides (such as magnesium hydride), silicides, phosphides, and nitrides. Still other examples include carbon-silicon combinations, such as carbon-coated silicon, silicon-coated carbon, carbon doped with silicon, silicon doped with carbon, and alloys including carbon and silicon. Similar combinations of carbon and germanium, as well as similar combinations of carbon and tin, may be used. Various aluminium-containing materials may be used as well.

Other examples of active materials for lithium ion cells can include lithium cobalt oxide and lithium iron phosphate (e.g., for a cathode) and graphite or other forms of carbon (e.g., for an anode). Structures formed from active materials, including high capacity active materials, may have various shapes and dimensions (e.g. spherical, tubes, fibrous morphology) depending on compositions, crystallographic structures (e.g., crystalline, amorphous), deposition process parameters, and many other factors. Shapes and sizes may also change during cycling.

Active materials, including high capacity active materials, can be generally formed into structures such that their cross-section dimensions are generally below their fracture limits. In certain embodiments, a cross-section dimension is between about 1 nm and 10,000 nm. In some embodiments, a cross-section dimension is between about 5 nm and 1000 nm, and more specifically between 10 nm and 200 nm. These dimension ranges are generally applicable to silicon containing high capacity active materials, such as amorphous or crystalline silicon.

Active materials, including high capacity active materials may be formed into various types of nanostructures, which have cross-section dimensions less than 1,000 nm, i.e., at least one nanoscale dimension. Some examples of nanostructures include nanofilms that have a nanoscale dimension along one axis, nanowires that have nanoscale dimensions along two axes, and nanoparticles that have nanoscale dimensions along all three axes.

In some embodiments, each layer of electrode composite material is independently characterised by a thickness of about 0.1 μm to about 1000 μm. In other embodiments, the thickness is about 0.2 μm to about 1000 μm, about 0.3 μm to about 1000 μm, about 0.4 μm to about 1000 μm, about 0.5 μm to about 1000 μm, about 0.6 μm to about 1000 μm, about 0.7 μm to about 1000 μm, about 0.8 μm to about 1000 μm, about 0.9 μm to about 1000 μm, about 1 μm to about 1000 μm, about 10 μm to about 1000 μm, about 50 μm to about 1000 μm, about 100 μm to about 1000 μm, about 150 μm to about 1000 μm, about 200 μm to about 1000 μm, about 250 μm to about 1000 μm, about 300 μm to about 1000 μm, about 350 μm to about 1000 μm, about 400 μm to about 1000 μm, about 500 μm to about 1000 μm, about 600 μm to about 1000 μm, about 700 μm to about 1000 μm, or about 800 μm to about 1000 μm.

In some embodiments, the electrode composite material comprises a carbon-based material, a metal-based material, a metal oxide based material, an electrochemically active material, a polymeric material or a combination thereof.

In some embodiments, the carbon-based material is selected from natural graphite, artificial graphite, carbon black, acetylene black, ketjen black, carbon fiber, graphene or a combination thereof. In some embodiments, the electrode composite material comprises an electrically conductive nanoparticle. In some embodiments, the electrically conductive nanoparticle comprises graphene, carbon black, acetylene black, carbon nanotubes, metallic nanoparticles such as silver nanoparticles, carbon dots, or a combination thereof.

In some embodiments, the electrically conductive nanoparticles are surface functionalised with different oxidation states of halides, chalcogenides, metals, or a combination thereof.

In some embodiments, the graphene nanoplatelets are surface functionalised with sulphur in order to form the electrochemically active material. Sulfur acts as a redox active material and undergoes redox reactions via conversion process. It can be used as a cathode against low voltage anode like Li metal as in Li—S battery or as an anode against high voltage cathodes.

In some embodiments, the electrode composite material comprises a metal-based material. The metal-based material can be bulk metal, metal powder metal fiber and/or metal-based material. For example, metals such as copper, nickel, aluminium, silver, niobium can be used.

The electrode composite material may be impregnated into the porous conductive substrate in a dry powder form (solid-state). In this regard, other components such as polymeric binders, solvents, or extra conductive materials (as necessarily in a slurry form) are not added. This simplifies the fabrication process and further improves its areal capacity, volumetric energy density and/or gravimetric energy density. Alternatively, the electrode composite material may be added as a slurry (wet form). In these cases, other components such as polymeric binders, solvents, or electrically conductive materials may be added to improve its flow and dispersal properties.

In some embodiments, the electrode composite material is characterised by an absence of a conductive polymer. In some embodiments, the electrode composite material comprises a conductive polymer. The conductive polymer may be polyphenylene and its derivative thereof.

In some embodiments, the electrode composite material is characterised by an absence of an electrically conductive nanoparticle. In some embodiments, a weight ratio of electrically conductive nanoparticle relative to the electrode composite material is about 1 wt % to about 50 wt %, about 3 wt % to about 50 wt %. In other embodiments, the weight ratio is about 5 wt % to about 40 wt %, about 6 wt % to about 30 wt %, about 70 wt % to about 20 wt %, about 8 wt % to about 15 wt %, about 9 wt % to about 10 wt %. In some embodiments, the weight ratio is less than about 50 wt %, about 40 wt %, about 30 wt %, about 20 wt %, about 10 wt %, about 5 wt %, or about 1 wt %. In some embodiments, a weight ratio of electrically conductive nanoparticle relative to the electrode composite material is about 10 wt %.

In some embodiments, the electrode composite material is characterised by an absence of additives. The electrode composite material can comprise other additives. In some embodiments, the electrode composite material further comprises a conductive filler. The conductive filling serves to improve the electrical contacts between the active material within an electrode thereby reducing the overall electrode impedance.

In some embodiments, the conductive filler is a carbon nano-object like conductive carbon, graphene nanoplatelets, silver nanoparticles, carbon nanotubes, carbon fibre, etc. Any electrically conductive material may be used as a conductive material, unless it causes a chemical change, and examples thereof may be natural graphite, artificial graphite, carbon black, acetylene black, ketjen black, carbon fiber, graphene and/or like carbon-based material; copper, nickel, aluminum, silver, niobium, and/or like metal powder or metal fiber and/or like metal-based material; polyphenylene derivative and/or like conductive polymer; and/or a mixture thereof.

In some embodiments, the electrode composite material is characterised by an absence of a conductive filler. In some embodiments, a weight ratio of the conductive filler relative to the electrode composite material is about 1 wt % to about 30 wt %. In some embodiments, a weight ratio of the conductive filler relative to the electrode composite material is about 1 wt % to about 20 wt %. In some embodiments, the weight ratio is less than about 30 wt %, about 25 wt %, about 20 wt %, about 15 wt %, about 10 wt %, about 5 wt %, or about 1 wt %. In some embodiments, a weight ratio of the conductive filler relative to the electrode composite material is about 10 wt %.

In some embodiments, the electrode composite material is characterised by an absence a binder. The electrode composite material can further comprise a binder for attaching the active material to a current collector substrate. In some embodiments, the electrode composite material further comprises a binder.

The binder may be a non-aqueous binder, an aqueous binder, or a combination thereof. The binder is not particularly limited as long as it binds the active material and the conductive material on a current collector, and simultaneously (or concurrently) has no electrochemical degradation.

Non-aqueous binders can be, but not limited to, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, polyamideimide, polyimide, or a combination thereof.

Aqueous binders can be either natural, modified, or synthesised materials include, but are not limited to, a rubber-based, a polymer resin, or a polysaccharide binder. Rubber-based binders may be selected from styrene-butadiene rubber, acrylated styrene-butadiene rubber (SBR), acrylonitrile-butadiene rubber, acrylic rubber, butyl rubber, fluorine rubber, natural rubber, and a combination thereof. Polymer resin binders may be selected from ethylenepropylene copolymer, epichlorohydrin, polyphosphazene, polyacrylonitrile, polystyrene, ethylenepropylenediene copolymer, polyvinylpyridine, chlorosulfonated polyethylene, a polyester resin, an acrylic resin, a phenolic resin, an epoxy resin, polyvinyl alcohol and a combination thereof.

Polysaccharide binders may be selected from carboxylmethyl cellulose, hydroxypropylmethyl cellulose, methyl cellulose, or their alkali metal salts thereof, gum tragacanth, gum arabic, gellan gum, xanthan gum, guar gum, karaya gum, chitosan, sodium alginate, cyclodextrin, starches, and a combination thereof. The alkali metal may be Na, K, or Li. Such a cellulose-based compound may be included in an amount of about 0.1 parts by weight to about 20 parts by weight based on 100 parts by weight of the active material. Preferable binders that may be mentioned herein are the sodium salt of carboxylmethyl cellulose, gum Arabic, polyvinyl alcohol, or a combination thereof.

In some embodiments, the binder is gum Arabic, polyvinyl alcohol, or a combination thereof. In some embodiments, the binder is polyvinylidene fluoride, gum Arabic, cellulose gum, polyvinyl alcohol, carboxylmethyl cellulose, styrene-butadiene rubber, or a combination thereof.

In some embodiments, a ratio of gum arabic to polyvinyl alcohol is about 1:1.

In some embodiments, the electrode composite material is characterised by an absence a binder. In some embodiments, a weight ratio of the binder relative to the electrode composite material is about 1 wt % to about 20 wt %. In other embodiments, the weight ratio is about 2 wt % to about 20 wt %, about 4 wt % to about 20 wt %, about 6 wt % to about 20 wt %, about 8 wt % to about 20 wt %, about 10 wt % to about 20 wt %, about 10 wt % to about 18 wt %, about 10 wt % to about 16 wt %, about 10 wt % to about 14 wt %, or about 10 wt % to about 12 wt %. In some embodiments, the weight ratio is less than about 20 wt %, about 18 wt %, about 16 wt %, about 15 wt %, about 10 wt %, about 5 wt %, or about 1 wt %. In some embodiments, a weight ratio of the binder relative to the electrode composite material is about 10 wt %.

The electrode may comprises a plurality of layers of electrode composite material. In other embodiments, at least three layers are present. In all these embodiments, each electrode composite material layer is separated from each other by the porous conductive substrate, and with the porous conductive substrate forming at least the external planar faces of the electrode. The electrode composite material layers can be the same, or can each comprise active materials and/or additives which are dissimilar, so as to provide each layer with dissimilar capacities.

As used herein, the “substrate” is a surface on which chemical reactions can be performed or supported. Accordingly, the porous conductive substrate provides a porous surface which is also conductive to charges. The substrate can be a flat sheet (in a macroscopic sense) of various thickness.

The porous conductive substrate or porous current collector material is a material that has a higher electronic conductivity than the active material. In some embodiments, the current collector layer may have a conductivity less than or equal to that of a current collector substrate, if present. In some embodiments, a material is such that the contact resistance per unit surface area of a current collector layer that is less than 10 Ohm-centimeter squared.

Examples of materials include metals such as copper, nickel, chromium, tungsten, metal nitrides, metal oxides, metal carbides, carbon, conductive polymers, and combinations thereof. In some implementations, the current collector layer can be a nanomaterial network, including nanofiber, nanowire, and nanotube network. Further examples of nanomaterial networks can include networks of spheres, cones, rods, tube, wires, arcs, belts, saddles, flakes, ellipsoids, meshes, laminate foams, tapes, and combinations thereof. The network may be a non-uniform, continuous film in some implementations.

That is, a film provides one or more continuous conductive pathways while allowing electrochemical species transport through the film. Electronically conductive binders can also be added to any of the current collectors described herein. In addition, combinations of materials, as described herein, can be used to form a current collector layer.

In some implementations in which current collector layer is nanostructured, the nanostructures may be oriented such that their longest dimension extends in a direction generally parallel to the plane of an underlying layer or, if present, a current collector substrate.

As noted above, in some implementations, a current collector layer contains carbon. The carbon may be, for example, carbon fibers or tubes, graphite, graphene, and/or carbon sheets. In one arrangement, the carbon is in the form of linear carbon nanostructures, such as nanofibers or nanotubes. The nanostructures can form a net over the active material layer. In another arrangement, the carbon is in the form of a graphene sheet containing one or more layers of graphene. In another arrangement, the carbon is in the form of amorphous carbon.

In some implementations, the current collector layer contains a metal such as copper or nickel. In one arrangement, the metal is in the form of linear nanostructures, such as nanowires. The nanostructures can form a net over the active material layer. In another arrangement, the metal is in the form of a thin sheet containing one or more atomic layers of metal. In such an arrangement, the thin sheet may be non-uniformly distributed.

In some embodiments, the porous conductive substrate is a non-metallic porous conductive substrate. This prevents any side reactions (e.g. oxidation of Cu, Fe, Ni) or plating typically observed with metallic current collectors (e.g. aluminium).

In some embodiments, the porous conductive substrate is selected from carbon paper, carbon cloth, carbon foam, carbon fibre, porous metallic structures, grids and foams, porous conductive polymers, conductive polymeric gels and aerogels, thin films, or a combination thereof.

Porosity is a measure of the void (i.e. “empty”) spaces in a material, and is a fraction of the volume of voids over the total volume, between 0 and 1, or as a percentage between 0% and 100%. The porosity can for example be measured using confocal microscopy, profilometer, AFM or gas absorption analysis methods (such as gas absorption porosimeter).

In some embodiments, the porous conductive substrate has a pore size of about 1 nm to about 20,000 nm. In other embodiments, the pore size is about 100 nm to about 20,000 nm, about 200 nm to about 20,000 nm, about 300 nm to about 20,000 nm, about 400 nm to about 20,000 nm, about 500 nm to about 20,000 nm, about 500 nm to about 18,000 nm, about 500 nm to about 15,000 nm, about 500 nm to about 10,000 nm, about 500 nm to about 5,000 nm, or about 500 nm to about 2,000 nm.

In some embodiments, the porous conductive substrate has a through plane air permeability of about 10 to about 50 Gurley unit. The Gurley second or Gurley unit is a unit that describes air permeability as a function of the time required for a specified amount of air to pass through a specified area of a separator under a specified pressure. Specifically, it is defined as the number of seconds required for 100 cubic centimeters (1 deciliter) of air to pass through 1.0 square inch of a given material at a pressure differential of 4.88 inches of water (0.176 psi) (ISO 5636-5:2003). In other embodiments, the through plane air permeability is about 15 to about 50 Gurley unit, about 15 to about 45 Gurley unit, about 20 to about 45 Gurley unit, about 25 to about 45 Gurley unit, about 30 to about 45 Gurley unit, or about 30 to about 40 Gurley unit. In other embodiments, the through plane air permeability is about 35 Gurley unit.

In some embodiments, the porous conductive substrate has a porosity of about 30% to about 90%. In other embodiments, the porosity is about 40% to about 90%, about 50% to about 90%, about 60% to about 90%, about 70% to about 90%, or about 80% to about 90%.

In some embodiments, the porous conductive substrate has an apparent porosity of about 60% to about 90%. Apparent Porosity can be defined as the quantity of void (or pores) present in a volume of porous solid. In other embodiments, the apparent porosity is about 65% to about 90%, about 70% to about 90%, about 70% to about 85%, or about 75% to about 80%.

In some embodiments, the porous conductive substrate has a connected porosity of about 50% to about 90%. Connected porosity can be defined as the void space through which an uninterrupted path exists between the borders of a volume or sub-volume of a substrate. Connected porosity can be measured through the volume of gas or liquids that can flow into the rock, whereas fluids cannot access unconnected pores. In other embodiments, the connected porosity is about 50% to about 85%, about 50% to about 80%, about 50% to about 75%, or about 55% to about 75%.

In some embodiments, the porous conductive substrate is surface functionalised. In some embodiments, the porous conductive material is functionalised with transition metal sulphides, transition metal selenides, halides, metal ions, nanoparticles, metal oxides, or a combination thereof. In some embodiments, the porous conductive substrate is functionalised with transition metal sulfides or selenides (e.g. NbS₂, MoS₂, CoS₂, NbSe₂) or halides (e.g. F, Cl, br) or metallic ions/nanoparticles (e.g. Cu, Al, Li, K, Na, Ag, Au, Ti, W, Ta, Nb) or metal oxides (e.g. Ti₄O₇, TiO₂, SiO2, Al₂O₃).

In some embodiments, the porous conductive substrate between the electrode composite material and at the terminal ends is independently characterised by a thickness of about 10 μm to about 1000 μm. In other embodiments, the thickness is about 10 μm to about 900 μm, about 10 μm to about 800 μm, about 10 μm to about 700 μm, about 10 μm to about 600 μm, about 10 μm to about 500 μm, about 10 μm to about 400 μm, about 10 μm to about 300 μm, or about 10 μm to about 200 μm. For example, when carbon paper is used, the thickness of one sheet of carbon paper is about 115 μm. Multiple sheets of carbon paper can be used. Stacking and compressing two sheets of carbon paper gives a thickness of about 175 μm.

In some embodiments, the electrode is characterised by an absence of a separator between the electrode composite material. A separator is a permeable membrane placed between the electrode composite materials. The separator functions to keep the two electrode composite materials apart to prevent electrical communication while allowing the transport of ionic charge carriers that are needed to close the circuit during the passage of current in an electrochemical cell. Only while assembling a cell, a separator may be required between the anode and cathode which can be separately made of stacked electrodes. Typical separators are polypropylene, polyethylene, nylon or the likes.

For example, two carbon papers may be used as the porous conductive substrate to sandwich a layer of electrode composite material. After lamination, the final thickness of the full electrode (2×carbon paper+electrode material) may be the same as 1 carbon paper alone. In this way the volumetric energy density is not compromised.

In some embodiments, when the electrode contains sulfur as the active material, it is characterised by a discharge capacity of about 50 mAh g_{active material}⁻¹ to about 4000 mAh g_{active material}⁻¹. In other embodiments, the discharge capacity is about 200 mAh gs⁻¹ to about 1,450 mAh gs⁻¹, about 200 mAh gs⁻¹ to about 1,300 mAh gs⁻¹, about 200 mAh gs⁻¹ to about 1,250 mAh gs⁻¹, about 400 mAh gs⁻¹ to about 1,250 mAh gs⁻¹, about 600 mAh gs⁻¹ to about 1250 mAh gs⁻¹, about 700 mAh gs⁻¹ to about 1250 mAh gs⁻¹, or about 800 mAh gs⁻¹ to about 1250 mAh gs⁻¹. In some embodiments, the electrode is characterised by a discharge capacity of about 1,240 mAh gs⁻¹.

In some embodiments, when the electrode contains NMC 811 (composition with 80% nickel, 10% manganese, and 10% cobalt), it is characterised by a discharge capacity of about 200 mAh g_{active material}⁻¹.

In some embodiments, the electrode is characterised an areal capacity of about 2 mAh cm⁻² to about 100 mAh cm⁻². In other embodiments, the areal capacity is about 3 mAh cm 2 to about 50 mAh cm⁻², about 4 mAh cm⁻² to about 25 mAh cm⁻², about 5 mAh cm⁻² to about 20 mAh cm⁻², about 6 mAh cm⁻² to about 10 mAh cm⁻², about 7 mAh cm⁻² to about mAh cm⁻², or about 8 mAh cm⁻² to about 10 mAh cm⁻².

In some embodiments, the electrode is characterised by a volumetric energy density of about 500 Wh L⁻¹ to about 1000 Wh L⁻¹. In other embodiments, the volumetric energy density is about 300 Wh L⁻¹ to about 800 Wh L⁻¹, about 400 Wh L⁻¹ to about 800 Wh L⁻¹, about 500 Wh L⁻¹ to about 800 Wh L⁻¹, about 600 Wh L⁻¹ to about 800 Wh L⁻¹, or about 700 Wh L⁻¹ to about 800 Wh L⁻¹.

In some embodiments, the electrode is characterised by a gravimetric energy density of about 40 Wh kg⁻¹ to about 600 Wh kg⁻¹. In other embodiments, gravimetric energy density is about 100 Wh kg⁻¹ to about 600 Wh kg⁻¹, about 150 Wh kg⁻¹ to about 600 Wh kg⁻¹, about 200 Wh kg⁻¹ to about 600 Wh kg⁻¹, about 250 Wh kg⁻¹ to about 600 Wh kg⁻¹, about 300 Wh kg⁻¹ to about 600 Wh kg⁻¹, about 350 Wh kg⁻¹ to about 600 Wh kg⁻¹, about 400 Wh kg⁻¹ to about 600 Wh kg⁻¹, about 450 Wh kg⁻¹ to about 600 Wh kg⁻¹, or about 500 Wh kg⁻¹ to about 600 Wh kg⁻¹.

In some embodiments, the electrode is characterised an electronic conductivity of about 1.5 S cm⁻¹ to about 100 S cm⁻¹. In other embodiments, the electronic conductivity is about 1.5 S cm⁻¹ to about 100 S cm⁻¹, about 2 S cm⁻¹ to about 100 S cm⁻¹, about 5 S cm⁻¹ to about 100 S cm⁻¹, about 10 S cm⁻¹ to about 100 S cm⁻¹, about 20 S cm⁻¹ to about 100 S cm⁻¹, about 30 S cm⁻¹ to about 100 S cm⁻¹, about 40 S cm⁻¹ to about 100 S cm⁻¹, about 50 S cm⁻¹ to about 100 S cm⁻¹, about 60 S cm⁻¹ to about 100 S cm⁻¹, about 70 S cm⁻¹ to about 100 S cm⁻¹, or about 80 S cm⁻¹ to about 100 S cm⁻¹.

In some embodiments, the electrode is characterised by a capacity loss of about 5% to about 50% relative to its initial capacity. In other embodiments, the capacity loss is about 5% to about 45%, about 5% to about 40%, about 5% to about 35%, about 5% to about 30%, about 5% to about 25%, about 5% to about 20%, or about 5% to about 15%.

In some embodiments, the electrode is characterised by a Coulombic efficiency of about 70% to about 100%. In other embodiments, the Coulombic efficiency is about 75% to about 100%, about 80% to about 100%, about 85% to about 100%, about 90% to about 100%, or about 95% to about 100%.

In some embodiments, the electrode is characterised by a cycle life of more than 40 cycles.

In some embodiments, when sulphur is the active material, the electrode is characterised by a cycle life of more than 40 cycles at about 0.25 current rate, a discharge capacity of about 900 mAh gs⁻¹ and a Coulombic efficiency of more than 90% is obtainable.

In some embodiments, the electrode further comprises a joint adapted to pass through the electrode. For example, the joint may pierce the electrode. In some embodiments, the joint is adapted to pass through a through hole formable in the electrode.

The joint serves to electrically connect the electrode to other components of a battery, cell or electrical system. The inventors have further found that peculiarities regarding the characteristics of certain materials used as current collectors or self-standing electrodes (e.g., used in solid-state batteries), which prohibit contact-tabs or leads from being attached to them (or at least limits their connectivity), are due to welding methods commonly used in this field. Examples of such materials are the carbon-based current collectors (e.g. carbon paper, carbon foam, carbon cloth, carbon fibre, etc.) and the alkali and alkaline-earth metal/alloy electrode foils. Towards this end, the inventors have found that a joint can be used to overcome or at least ameliorate these problems.

For example, a joint can be used to connect/bind/join one or more electrodes to each other. The joint can also be used to connect one or more electrodes to a contact tab/lead. The joint can also be used to connect one or more leads from individual cells to a contact tab in order to achieve physical contact between them. By using a joint, the need of welding is avoided. The joint allows a mechanical resistant connection between the current collectors and a metallic tab/lead and does not compromise or change the electrical conductivity across the entire system (tab/lead+current collector). As the electrical conductivity measured through the current collector alone is the same when measured with the joint/tab (FIG. 9), this shows that the joint does not compromise the electrical conductivity.

The use of joints instead of high heat to melt the parts together which causes fusion in welding allows the use of non-weldable materials as current collectors for electrodes (e.g. carbon-based current collectors and the alkali and alkaline-earth metal/alloy electrode foils). The joints can also be integrated in a manufacturing process as a simple and automatable method, and thus is scalable. There is lower energy consumption compared to welding, which saves energy and reduce costs. It was found that the joints provide more robust and durable join compared to welding, leading to lower battery failures and batch rejection and is suitable for flexible batteries and fragile electrodes. As the joints are customisable, they can be used for varied battery applications, configurations, and chemistries. The joints are also suitable for use in liquid electrolyte batteries and solid-state batteries. Additionally, excessive energy lost and localised heating due to the uncontrollable formation of the weld is also avoided.

In some embodiments, the joint comprises a body adapted to substantially pass through the electrode. For example, the body may comprise at least one tapered end in order to pierce the electrode.

In some embodiments, the body is characterised by a cross sectional shape selected from a circle, oval, or polygon. The polygon can be a triangle, square, diamond, rectangle, star shape, pentagon or hexagon. Using a different cross sectional shape allows the surface area to be increased such that the more points of contact can be created.

In some embodiments, the body is hollowed.

In some embodiments, when the body is characterised by a polygonal cross sectional shape and is hollowed, the body comprises legs extending from edges of the polygon.

In some embodiments, the joint further comprises a head at a first end of the body. The head prevents the body from being removed from the electrode at the first end thereof.

In some embodiments, the body is deformable to form a head. In other embodiments, the body is deformable to form a head at a second end of the body. This secures the joint to the electrode. In this regard, the length of the body is longer than a thickness of the electrode.

In some embodiments, the joint comprises an electrically conductive material. In some embodiments, the electrically conductive material is selected from metal, alloy or a composite. In some embodiments, the electrically conductive material is selected from stainless steel, Al, Ti, Ni, or Cu. In some embodiments, when the electrode is a cathode, the electrically conductive material is selected from stainless steel, Al, Ti, or Ni. In some embodiments, when the electrode is an anode, the electrically conductive material is selected from stainless steel, Ni or Cu.

In some embodiments, the joint is adapted to electrically connect two or more electrodes. In some embodiments, the joint is adapted to electrically connect at least one electrode to at least one contact tab. In some embodiments, the joint is adapted to electrically connect at least one electrode to at least one lead. In some embodiments, the joint is adapted to electrically connect at least one contact tab to at least one lead on the electrode. The joint can also be used to electrically connect at least one contact tab on the electrode to at least one lead. The joint can also be used to electrically connect at least one contact tab to at least one lead.

The present invention also provides an electrode, and a joint passing through the electrode.

In some embodiments, the electrode comprises a through hole, wherein the joint passes through the through hole in the electrode.

The present invention also provide a joint as disclosed herein.

The present invention provides a method of fabricating an electrode, comprising:
a) forming at least one electrode layer, the at least one electrode layer is formed by coating a layer of electrode composite material on at least a surface of a porous conductive substrate; and
b) stacking the at least one electrode layer with another porous conductive substrate such that the layer of electrode composite material is sandwiched between the porous conductive substrates, the at least one electrode layer in electrical communication with the porous conductive substrates;
wherein the electrode composite material at least partially impregnates the porous conductive substrates.

In some embodiments, the method further comprises a step of stacking another electrode layer on the porous conductive substrate of step a) or b). The electrode layer may be stacked on a surface of the porous conductive substrate. The surface may be an exposed surface; i.e. not coated with electrode composite material. In this way, a plurality of electrode layers can be built up to form a single electrode. This step can thus be repeated to increase the electrode layers of the electrode.

In some embodiments, a method of fabricating an electrode comprises:
a) forming at least two electrode layers, each electrode layer is formed by coating a layer of electrode composite material on at least a surface of a porous conductive substrate; and
b) stacking the electrode layers with another porous conductive substrate such that each layer of the electrode composite material is sandwiched between the porous conductive substrates, the at least two electrode layers in electrical communication with the porous conductive substrates;
wherein the electrode composite material at least partially impregnates the porous conductive substrates.

The electrode layers may be stacked adjacent to each other such that the layer of electrode composite material on a first electrode layer faces an uncoated surface of the porous conductive substrate of a second electrode layer. This arrangement allows two electrode layers to be formed parallel to each other.

In some embodiments, the method further comprises a step of stacking another electrode layer on the porous conductive substrate of step a) or b). The electrode layer may be stacked on a surface of the porous conductive substrate. The surface may be an exposed surface; i.e. not coated with electrode composite material. In this way, a plurality of electrode layers can be built up to form a single electrode. This step can thus be repeated to increase the electrode layers of the electrode to three or more.

In some embodiments, the electrode composite material is be provided as a slurry, dough, paste, or powder.

In some embodiments, the step of forming the electrode layer comprises drying the electrode composite material.

In some embodiments, when the electrode layer is a slurry, it is dried for about 2 h to about 24 h. In other embodiments, the duration is about 4 h to about 24 h, about 6 h to about 24 h, about 8 h to about 24 h, about 10 h to about 24 h, about 12 h to about 24 h, about 12 h to about 20 h, about 14 h to about 20 h, or about 16 h to about 20 h.

In some embodiments, when the electrode layer a slurry, it is dried at about 40° C. to about 80° C. In other embodiments, the temperature is about 50° C. to about 80° C., or about 50° C. to about 70° C. In some embodiments, the electrode layer is dried at about 60° C.

In some embodiments, the electrode composite material is characterised by a mass loading on the surface of the porous conductive substrate of about 1 mg cm⁻² to about 100 mg cm⁻². In other embodiments, the mass loading is about 1 mg cm⁻² to about 90 mg cm 2, about 2 mg cm⁻² to about 80 mg cm⁻², about 3 mg cm⁻² to about 70 mg cm⁻², about 4 mg cm⁻² to about 60 mg cm⁻², about 5 mg cm⁻² to about 50 mg cm⁻², or about 10 mg cm 2 to about 30 mg cm⁻². In some embodiments, the electrode composite material is characterised by a mass loading on the surface of the porous conductive substrate of about mg cm⁻².

In some embodiments, the stacking step comprises subjecting the electrode layer and the another porous conductive substrate to a compressive force. The compressive force allows the electrode composite material to at last partially impregnates the porous conductive substrate. In some embodiments, the compressive force is provided by a hydraulic press, gravimetric press, roller press or a pneumatic press. In some embodiments, the stacking step comprises laminating the electrode layers and the another porous conductive substrate.

In some embodiments, the method further comprises connecting a joint to the electrode.

In some embodiments, the joint is connected to the electrode via punching or via a through hole formed in the electrode.

In some embodiments, the joint comprises a body, wherein the body is deformable to form a head.

In some embodiments, the body is deformed by bending an end of the body such that the head is substantially parallel to a surface of the electrode. In some embodiments, the body is bent in a direction away from its longitudinal axis.

The present invention also provide a method of connecting a joint to an electrode, comprising:
a) passing a body of the joint through the electrode; and
b) deforming the body of the joint in order to form a head for connecting the joint to the electrode.

### Production of the Individual Electrode Layers

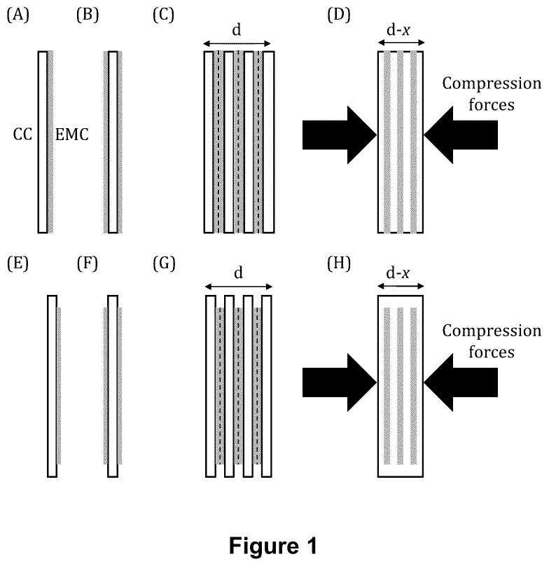

Electrode composition consisting of active material, conductive material, binder, and any other additives as required for the optimal performance of the electrode can be coated or deposited onto the porous conductive substrate to produce the individual electrode layers (IEL) (FIG. 1).

The IEL can be coated on a single side or double side of the porous conductive substrate with similar or different amounts of active material on them. The IEL can be coated such that it covers the whole of the longitudinal surface of the substrate. Alternatively, the coating can be done in such a way that a small portion of the substrate may remain uncoated (thus forming a border surrounding the IEL) to guarantee electronic contact with the side edges of the coatings. Another possibility to ensure electronic contact is to glue or stick using conductive glue or paste (Glue or paste or binders containing silver nanoparticles, copper nanoparticles, graphene or Carbon nanotubes or conductive carbon materials) or clamp together the substrates using a conductive material made of Al, Cu, Ni, Ti Pb or W.

### Production of Stacked Electrode (SE)

The IEL is placed one over the other in such a way that the coated surfaces having electrode composite material face each other and the outer surfaces of the IEL is an uncoated face of a substrate. Depending on the number of stacks, multiple double side coated layers of IEL can be stacked between two single side coated IELs (FIG. 1).

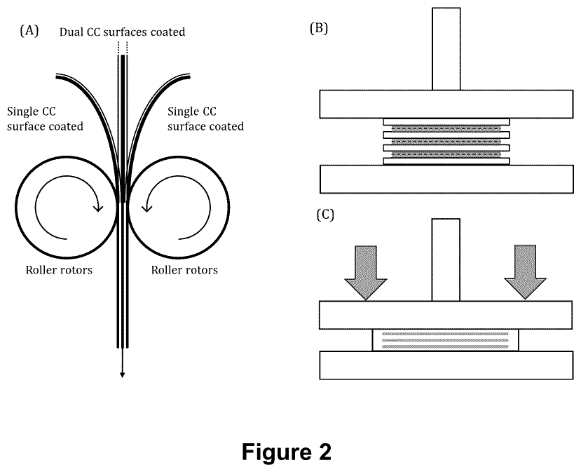

The stacked IEL is then pressed together to form the SE. No separator are placed between the IEL stacking layers. The stacking process can be performed using hydraulic/pneumatic press for batch production of SE or using roller press for the continuous production of SE (FIG. 2).

As the conductive substrate or current collector (CC), the substrates materials are electronically conductors and allow the passage of ions through its structure. For example carbon paper, carbon cloth, carbon foam, porous metallic structures (e.g. metallic foams), porous conductive polymers, conductive polymeric gels and aerogels, thin films (e.g. produced by deposition methods such as CVD, PVD, TVD, among others), etc. can be used as current collectors.

The final SE will not will not need any coating on the external surfaces. It was found that the ECM is enclosed between the stacks in such a way that the substrates helps to hold in the electrolyte-soluble and electrochemically-active species, thus prevent irreversible capacity loss, for example, during active material loss and polysulfide shuttling in the case of Li—S batteries. The surface of the current collectors can be functionalised or activated to improve its action to address this matter. Nevertheless, electronically conductive binders can also be coated on the areas uncoated by the ECM to guarantee electronic contact and the sealing of the ECM into the stacked configuration.

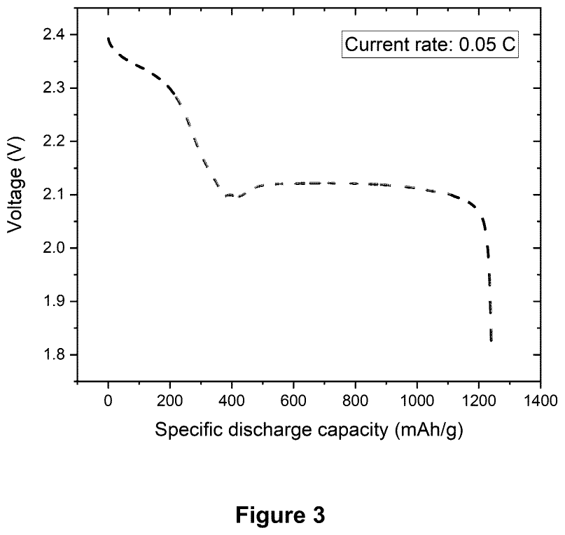

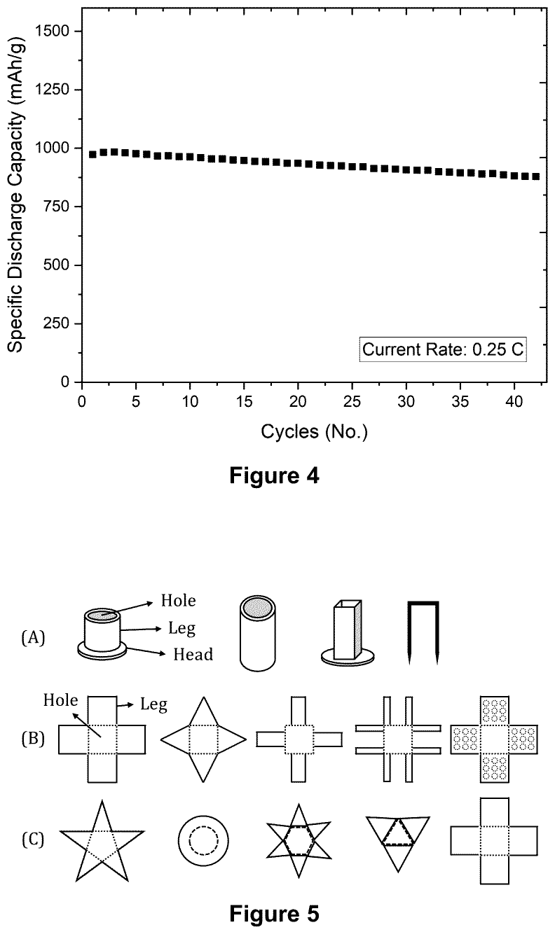

FIG. 3 presents the first specific discharge capacity at 0.05 current rate for a battery cell made with two individual electrodes staked together to form a sole cathode electrode. The first discharge capacity was found as 1,240 mAh gs⁻¹. FIG. 4 presents the specific discharge capacity over more than 40 cycles at of 0.25 current rate for the same cell. The cell returned an average capacity of 930 mAh gs⁻¹ and Coulombic efficiency higher than 90% over this test.

Accordingly, the electrode of the present invention can improve energy and/or power density, thus helps to solve the issue of underutilisation of active material and cell polarisation for thicker electrodes. Additionally, the electrode of the present invention can also improve capacity retention, which is one of the major problems seen in capacity degradation of battery electrodes where the electrochemically active material lose electronic contact with the electrode due to dissolution in electrolyte or to the structural collapse of the coating resulting from volumetric expansion related stress. These electrodes can also be used in liquid and gel-polymer electrolyte configurations. The method as disclosed is also scalable thus suitable for manufacturing.

### Connecting Joints

The joints are comprised of one or more pieces, and can have or not have, a pre-conformed head (FIG. 5A). The joints can be made of electrically conductive materials (e.g. metals, alloys, and composites) to ensure electrical conductivity across.

Preferably, the joints should be made of non-reactive materials concerning the electrolyte and electrodes of a particular electrochemical cell in which they will be used. For example, in Li—S batteries, aluminium is preferably used in the cathodes, and copper or nickel preferably used in the anode.

Electrochemical cells have different sizes and configurations. The proposed joints are agnostic in terms of geometric shape. For example, the joints can be made in wire shape, plate shape, hollow cylinder shape, hollow square shape, hollow triangle shape, hollow hexagon shape, etc. (examples at FIGS. 5B and 5C). It is frequently desirable to reduce the weight of non-active materials on electrochemical cells. From this perspective, the shape of the joints' legs can be optimised to have reduced weight. For example, the sizes can be reduced, or flanges/holes can be made in the joints' legs to remove material content and thereby weight (examples at FIG. 5B).

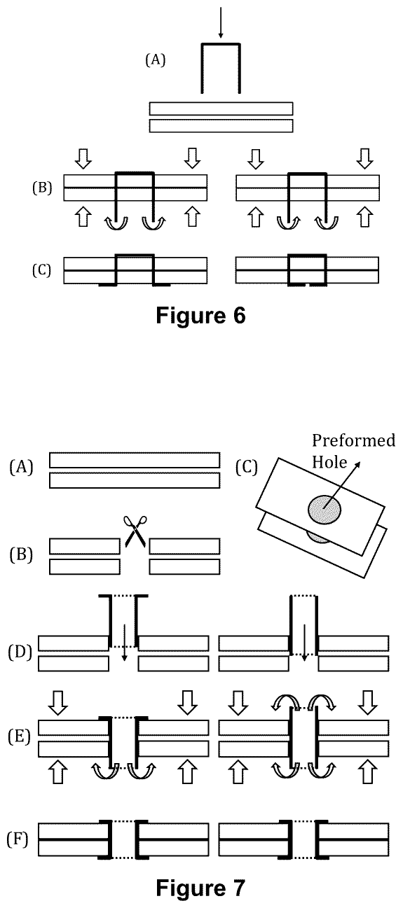

An appropriate shape and size must be chosen to guarantee that the contact among the parts lasts for a longer duration than the electrochemical cell in which they are inserted. For example, in a typical Li-ion pouch cell with a life of 1,000 cycles and dimensions of 40×20×3.5 mm (L×W×H) and tabs/leads with a width of 2 mm, the joint can have the shape of a two-pronged fastener connected by a head and be made of stainless steel, Al, Ti, or Ni for the cathode, and stainless steel, Ni, or Cu for the anode. In this case, the joint should have durability for at least 1,000 cycles (example of method at FIG. 6).

Pouch cells with dimensions of, for example, 290×216×7.1 mm (L×W×H), can use joints with ring shapes (cylindrical) or edge strip shapes (e.g., cubic, hexagonal, triangular, etc.) inserted into holes (preformed or not) through the electrodes, tabs, and/or leads and flared/collared/bent on each side (example of method at FIG. 7).

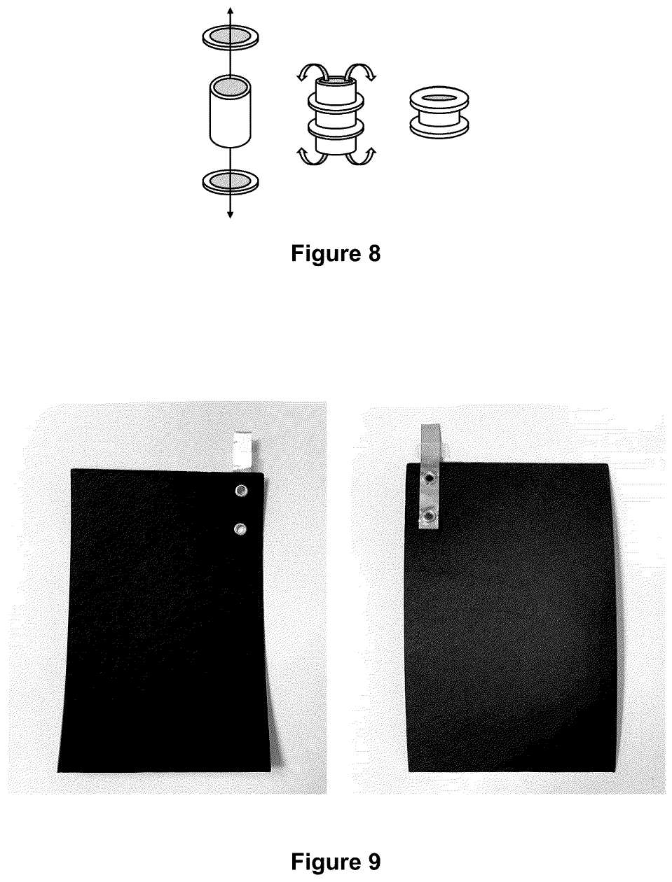

To join mechanically fragile, thin, or delicate electrodes, tabs, and/or leads, joints with two heads and a body can be used to promote higher mechanical stability and resistance to the joining process. This class of joint is comprised of two or more pieces (example of three pieces in FIG. 8).

### EXAMPLES

### Example 1: Fabrication of Stacked Electrode (SE) for Li—S Battery

IEL for cathode used in Li—S battery was fabricated as follows
Electrode composition: 80 wt. % sulfured graphene nanoplatelets, 10 wt. % conductive carbon, and 10 wt. % polyvinylidene fluoride (PVDF) as binder
Substrate: conductive carbon paper
Mass loading: 3 mg cm⁻²

Multiple IEL were fabricated and dried at 60° C. overnight before stacking. Two IEL were stacked together by using a hydraulic press.

### Example 2: Fabrication of Stacked Electrode (SE) for Li—S Battery

IEL for cathode used in Li—S battery was fabricated as follows
Electrode composition: 100 wt. % sulfured graphene nanoplatelets
Substrate: conductive carbon paper
Mass loadings: 1 to 6 mg cm⁻²

Dried electrode composite material were stacked between porous current collector using a hydraulic press.

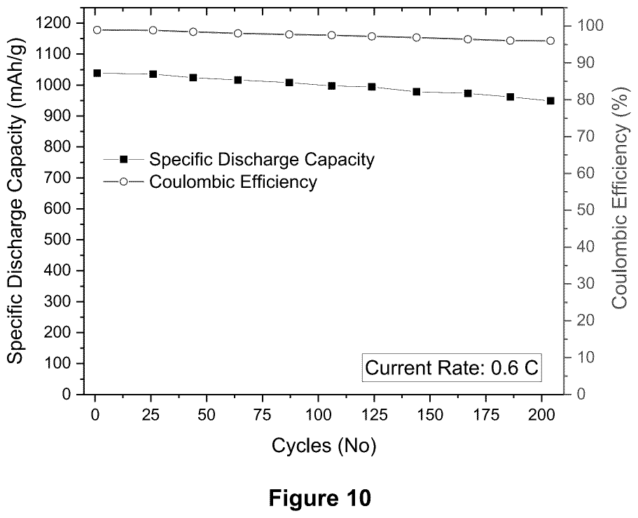

The stacked electrode in this example comprises 2 substrates and a layer of electrode composite material. FIG. 10 shows the specific discharge capacity of a cell made using this electrode. This shows the performance of the electrode under cycling.

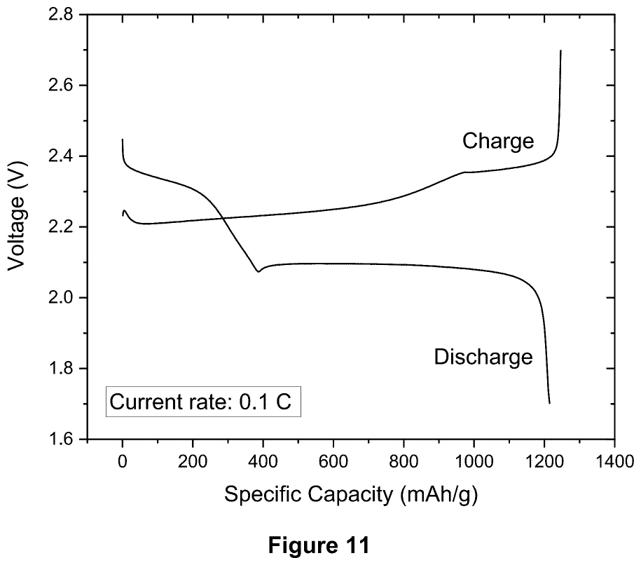

FIG. 11 shows that the change/discharge profile of an electrode formed using a dry powder method is similar to the electrode obtained by slurry coating method (FIG. 3).

### Example 3: Electrochemical Testing of SE in Li—S Battery

As an example, the resulting SE obtained from Example 1 were evaluated for its electrochemical performance against Li metal as the counter and the reference electrode. The configuration of the cells was kept as standard as possible to evaluate the as-synthesised materials' performance and to compare with the technical literature, that means the cells were not optimised or configured to improve the capacity, rate capability, cycle life, etc., which also depends on many factors such as the composition of the cathode, composition of the electrolyte, additives, electrolyte/sulphur ratio, interlayers, etc.

Electrochemical testing procedure in coin cells CR2032:
Cathode: SE cathode as described in example 1
Separator: Celgard 2325.
Electrolyte composition: 1M lithium bis(trifluoromethanesulfonyl)imide in 1,2-dimethoxyethane: 1,2-dioxolane (1:1 v/v)
Electrolyte volume: 40 uL
Galvanostatic cycler: Neware, model BTS 4000, at room temperature, with a discharge cut-of voltage at 1.8 V and charge termination at 2.37 V

It will be appreciated that many further modifications and permutations of various aspects of the described embodiments are possible. Accordingly, the described aspects are intended to embrace all such alterations, modifications, and variations that fall within the spirit and scope of the appended claims.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

Throughout this specification and the claims which follow, unless the context requires otherwise, the phrase “consisting essentially of”, and variations such as “consists essentially of” will be understood to indicate that the recited element(s) is/are essential i.e. necessary elements of the invention. The phrase allows for the presence of other non-recited elements which do not materially affect the characteristics of the invention but excludes additional unspecified elements which would affect the basic and novel characteristics of the method defined.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

1. An electrode, comprising:
a) a plurality of porous conductive substrates; and
b) at least one layer of an electrode composite material, the at least one layer of electrode composite material is sandwiched between the plurality of porous conductive substrates, the at least one layer of electrode composite material in electrical communication with the plurality of porous conductive substrates;
wherein the electrode composite material at least partially impregnates the plurality of porous conductive substrates.

2. The electrode according to claim 1, wherein the plurality of porous conductive substrates and the at least one layer of electrode composite material are laminated to each other.

3. (canceled)

4. The electrode according to claim 1, wherein the plurality of porous conductive substrates and the layer of electrode composite material have substantially the same planar area or wherein the porous conductive substrate is characterised by a larger planar area than a planar area of the layers of electrode composite material by about 1% to about 50%.

5. The electrode according to claim 1, wherein the electrode further comprises a binder in contact with its lateral sides thereof in order to electronically connect lateral sides of the electrode composite material to the porous conductive substrate.

6. The electrode according to claim 1, wherein the porous conductive substrate is selected from carbon paper, carbon cloth, carbon foam, carbon fibre, porous metallic structures, grids and foams, porous conductive polymers, conductive polymeric gels and aerogels, thin films, or a combination thereof and wherein the porous conductive substrate is surface functionalised with transition metal sulphides, transition metal selenides, halides, metal ions, nanoparticles, metal oxides, or a combination thereof.

7. The electrode according to claim 1, wherein each layer of porous conductive substrate is independently characterised by a thickness of about 10 μm to about 1000 μm; and/or
wherein each layer of electrode composite material is independently characterised by a thickness of about 0.1 μm to about 1000 μm.

8.-9. (canceled)

10. The electrode according to claim 1, wherein the electrode composite material is characterised by an absence of electrically conductive material, binder, filler, or a combination thereof.

11. The electrode according to claim 1, wherein the electrode composite material comprises electrically conductive nanoparticles selected from graphene, carbon black, acetylene black, carbon nanotubes, metallic nanoparticles, carbon dots, or a combination thereof;
Wherein the electrically conductive nanoparticles are surface functionalised with different oxidation states of halides, chalcogenides, metals, or a combination thereof;
Wherein a weight ration of electrically conductive nanoparticle relative to the electrode composite material is about 3 wt % to about 50 wt %, or preferably about 10 wt %.

12.-13. (canceled)

14. The electrode according to claim 1, wherein the electrode composite material further comprises a conductive filler selected from a conductive carbon-based material, a metal, or a combination thereof;
wherein a weight ratio of the conductive filler relative to the electrode composite material is about 1 wt % to about 30 wt %, or preferably about 10 wt %.

15. (canceled)

16. The electrode according to claim 1, wherein the electrode composite material further comprises a binder selected from polyvinylidene fluoride, gum Arabic, polyvinyl alcohol, carboxymethyl cellulose, styrene-butadiene rubber, or a combination thereof;
wherein a weight ratio of the binder relative to the electrode composite material is about 1 wt % to about 20 wt %, or preferably about 10 wt %.

17. (canceled)

18. The electrode according to claim 1, wherein the electrode is characterised by an absence of a separator between the electrode composite material.

19. The electrode according to claim 1, wherein the electrode is characterised by at least one of the following:
a) a discharge capacity of about 50 mAh g_{active material}⁻¹ to about 4000 mAh g_{active material}⁻¹;
b) an areal capacity of about 2 mAh cm⁻² to about 100 mAh cm⁻²;
c) an electronic conductivity of about 1.5 S cm⁻¹ to about 100 S cm⁻¹;
d) a capacity loss of about 5% to about 50% relative to its initial capacity;
e) a Coulombic efficiency about 70% to about 100%;
f) a cycle life of more than 40 cycles.

20. The electrode according to claim 1, wherein the electrode further comprises a joint adapted to pass through the electrode;
wherein the joint is adapted to pass through a through hole formable in the electrode;
wherein the joint comprises a body adapted to substantially pass through the electrode, wherein the body is characterised by a cross sectional shape selected from a circle, oval, or polygon.

21.-23. (canceled)

24. The electrode according to claim 20, wherein when the body is characterised by a polygonal cross sectional shape and is hollowed, the body comprises legs extending from edges of the polygon.

25.-27. (canceled)

28. The electrode according to claim 20, wherein the joint is adapted to electrically connect two or more electrodes, electrically connect at least one electrode to at least one contact tab, electrically connect at least one electrode to at least one lead, or electrically connect at least one contact tab to at least one lead on the electrode.

29. A method of fabricating an electrode, comprising:
a) forming at least one electrode layer, the electrode layer is formed by coating a layer of electrode composite material on at least a surface of a porous conductive substrate; and
b) stacking the electrode layer with another porous conductive substrate such that the layer of the electrode composite material is sandwiched between the porous conductive substrates, the at least one electrode layer in electrical communication with the porous conductive substrates;
wherein the electrode composite material at least partially impregnates the porous conductive substrates.

30. The method according to claim 29, wherein the method further comprises a step of stacking another electrode layer on the porous conductive substrate of step a) or b).

31. The method according to claim 29, wherein the electrode composite material is provided as a slurry, dough, paste, or powder and/or is characterised by a mass loading on the surface of the porous conductive substrate of about 1 mg cm⁻² to about 100 mg cm⁻².

32. (canceled)

33. The method according to claim 29, wherein the stacking step comprises subjecting the electrode layer and the another porous conductive substrate to a compressive force.

34. (canceled)

35. The method according to claim 29, wherein the method further comprises connecting a joint to the electrode via punching or via a through hole formed in the electrode;
wherein the joint comprises a body, wherein the body is deformable to form a head.

36.-38. (canceled)
